(19) United States
(12) Patent Application Publication
(10) Pub. No.: US 2010/0309689 A1
(43) Pub. Date: Dec. 9, 2010

(54) Bootstrap Circuitry

(76) Inventor: David Coulson, Comberton (GB)

Correspondence Address: TAROLLI, SUNDHEIM, COVELL & TUMMINO L.L.P., 1300 EAST NINTH STREET, SUITE 1700, CLEVELAND, OH, 44114, US

(21) Appl. No.: 12/566,860

(22) Filed: Sep. 25, 2009

Related U.S. Application Data
(60) Provisional application No. 61/183,720, filed on Jun. 3, 2009.

(51) Int. Cl. H02M 3/335

(52) U.S. Cl. 363/16

(57) ABSTRACT

This invention generally relates to a bootstrap circuit for a switch mode power supply, a controller for a switch mode voltage converter, a switch mode flyback converter comprising the bootstrap circuit, a switch mode forward converter comprising the bootstrap circuit, and a method of bootstrapping a switch mode power converter. The bootstrap circuit comprises: a current bleed impedance (Rht1) to bleed current from an input power supply (VH+); circuitry to deliver current from the input power supply (VH+) via the current bleed impedance (Rht1) to the base of a power switch (Q1) such that the power switch (Q1) is operable to amplify the current delivered from the internal power supply; a passive circuit (Dst) to provide the amplified current to a reservoir capacitor (Cdd); and the passive circuit element (Dst) further to substantially block reverse current flow from the supply input (Vdd) to the emitter of the power switch (Q1).

### RELATED APPLICATIONS

The present invention claims priority from U.S. Provisional Patent Application No. 61/183,720, filed Jun. 3, 2009.

### FIELD OF THE INVENTION

The invention generally relates to a method of bootstrapping a switch mode power converter, bootstrap circuits for a switch mode power supply, a controller for a switch mode voltage converter, and a switch mode voltage converter. In particular, the invention relates to a bootstrap circuit further comprising brownout protection circuitry.

### BACKGROUND TO THE INVENTION

A schematic diagram of a Switched Mode Power Supply (SMPS) having an emitter-switched flyback topology is shown in FIG. 1. In a fully operational (‘normal’) state, the supply current for the controller integrated circuit (IC) is delivered to the Vdd terminal from an auxiliary (or bias) winding, via diode (Daux) and reservoir capacitor (Cdd). However, during the start-up (also referred to as ‘bootstrap’) phase, which occurs after initial switch-on and before the auxiliary winding supply is operational, an alternative source of IC supply current may be required to activate the IC and enable the first switching cycles. In the approach of FIG. 1, this start-up current is provided directly to the reservoir capacitor (Cdd) from a high voltage rectified mains rail (VH+) via a resistor (Rht). Once the reservoir capacitor (Cdd) has been charged up to a desired threshold, the IC is activated and begins switching the internal switch (S1), thereby switching the external power transistor (Q1).

For use in understanding the present invention, the following disclosures are referred to:
U.S. Pat. No. 5,285,369 (Power Integrations Inc);
U.S. Pat. No. 5,369,307 (NEC Corp);
U.S. Pat. No. 5,581,453A (Matsushita Electric Ind Co Ltd);
U.S. Pat. No. 6,775,164 (Tyco Electronics Corp);
U.S. Pat. No. 7,345,894 (Sawtell & Menegoli)
US2003/0174005 (Tyco Electronics Corp)
US2009/0040793 (Active-Semi International Inc).

It is noted that, in the summary and detailed description below, one or more drawing references or abbreviations, e.g., Dst, Rht1, Q1, etc. is frequently provided in brackets after a term. Such drawing references or abbreviations are merely provided to assist understanding of embodiments and does not limit any term to any particular circuit element or circuitry indicated elsewhere in the present application as corresponding to the drawing reference or abbreviation. It is further noted that terms such as “switch mode power converter”, “switch mode voltage converter” and “switch mode power supply” are used interchangeably within the present application. For example, reference to a switch mode power converter (SMPC) may further refer to a switch mode voltage converter (SMVC) or switch mode power supply (SMPS).

### SUMMARY

According to a first aspect of the present invention, there is provided a method of bootstrapping a switch mode power converter (SMPC), the SMPC having: an input to receive power for said power converter; an internal power supply derived from said power received at said input; an output to provide a DC output voltage; a power switch; a controller to control said power switch, said controller having a threshold operating voltage; a transformer having a primary winding and a secondary winding coupled between said input and said output; said secondary winding being coupled to provide power for said DC output; said primary winding being coupled in series with said power switch and coupled to receive power derived from said input to receive power; an auxiliary power supply being configured to provide a power supply to said controller; the SMPC further comprising a controller power supply capacitor to store charge derived from said auxiliary power supply during operation of said SMPC for providing said power supply to said controller, the method comprising: bleeding current from said internal power supply into the input of a current amplifier; and charging said controller power supply capacitor from a current output of said current amplifier via a passive circuit such that when a voltage of charge on said controller power supply capacitor derived from said auxiliary power supply is less than said threshold operating voltage, said power supply to said controller is provided by said charging of said controller power supply capacitor from said current output of said current amplifier and wherein said passive circuit substantially inhibits current flow off said controller power supply capacitor towards ground.

For example, the above providing of the power supply to said controller by said charging of said controller power supply capacitor from said current output of said current amplifier may occur when the auxiliary power supply is off or at least not fully in operation, e.g., when the voltage on/current from the auxiliary power supply is zero.

Furthermore, the above charging of said controller power supply capacitor from a current output of said current amplifier may occur under any other condition when the voltage of charge on the controller power supply capacitor derived from the auxiliary power supply is insufficient to power the controller, e.g., is less than the threshold operating voltage (which may be alternatively described as a predetermined operating voltage; all references throughout the present specification to a threshold may alternatively be to a predetermined value). For example, such other condition may be a fault condition, this in embodiments resulting in a cessation of switching of the power switch. In other words, the method of bootstrapping of the first aspect may be used at any time when the voltage at the power supply input (e.g., pin (Vdd)) of the controller drops below a threshold operating voltage. More specifically, the voltage of charge on the controller power supply capacitor derived from the auxiliary power supply may be insufficient to power the controller if the voltage is less than that required to activate a power or voltage regulator internal to the controller.

The above input to receive power for said power converter may receive DC (direct current) or AC (alternating current) power.

The above internal power supply, which may supply power derived from said power received at said input, may supply AC or DC power. For example, the internal power supply may be an internal DC power supply or may use AC mains (wall/line/grid power). Such use of the AC mains may advantageously allow a smaller bootstrap resistor (e.g., Rht—see below), preferably while maintaining low power dissipation in such a resistor. Another arrangement may be identical to the first aspect except in that the internal power supply derives power from an internal or external source other than the power received at the input as in the first aspect—for example the source may be a battery, and/or the internal power supply may comprise such an internal source. (References to a ‘power supply’ as an object throughout this specification may mean a power line or circuitry configured to deliver power, e.g., from another power source).

The primary winding may be coupled to receive power derived from said input to receive power. In the case of receiving AC power at the above input to receive power for said power converter, a rectifier, e.g., bridge rectifier, may be provided between said input and the primary winding. In the case of receiving DC power at the above input to receive power for said power converter, the input may be connected directly or indirectly to the primary winding without any intervening rectifier.

Where the above input to receive power and the internal power supply are both DC, the internal power supply may be the input to receive power or a power supply line directly connected to the input.

The passive circuit may comprise one or more passive circuit elements, e.g., at least one diode. As in general for all optional features of the first aspect, this particular feature applies to all other aspects described in the present specification.

In particular, the auxiliary power supply may be internal to the SMPC, and thus may comprise an auxiliary winding of the transformer. This statement further applies to all references to an auxiliary power supply throughout this specification and therefore to each embodiment described herein.

Where the power switch comprises a bipolar transistor emitter switched device, the above method (or the method of operating a SMPC as described below regarding the further aspect) may further comprise using said controller to switch said emitter connection of said bipolar transistor power switch to ground. The switching may be on and off to ground. This may be achieved using a switch element (S1), e.g., bipolar or FET transistor, of the controller. Thus, embodiments of the invention may be particularly applicable for emitter-switched SMPCs.

By implementing an emitter-switched SMPC, reverse bias breakdown, with which a reverse bias safe operating area (RBSOA) may be associated, may be more easily avoided. Further in this regard, it may be advantageous to select as the power switch (Q1) of an embodiment a bipolar transistor having low parasitic impedances. Particularly advantageously, impedances to minimise include the Miller (collector-base) capacitance, the base spreading resistance and the collector-emitter capacitance. This may help to avoid the case that the emitter of the power switch rises to a higher voltage, e.g., 4V, relative to the base voltage, e.g., 3V, of the power switch (Q1). Such a case may for example occur when the controller has just switched the power switch off.

The current amplifier of an embodiment may advantageously allow a short start-up, i.e., bootstrap, time, so that normal use of the SMPC can begin without undue delay after initial switch-on of the main power input to the SMPC, e.g., after initial switch-on of an AC mains voltage to be rectified and converted. In particular, the controller power supply capacitor, which may determine the controller supply input voltage (Vdd) and may be internal or external to the controller, may charge more quickly due to the use of the current amplifier.

The current amplifier may comprise the power switch, which may be a power switching device in the form of, e.g., a bipolar or field effect transistor. The bleeding of said current from said internal power supply may then comprise bleeding current though a resistor into a control terminal of said power switch, wherein said output of said current amplifier comprises a connection to a switched terminal of said power switch. In this way, the above current amplification may be achieved to advantageously minimise the start-up time.

Since the current through the resistor may be amplified, the resistor (a “bootstrap impedance”, e.g., Rht) in an embodiment of the first aspect may have relatively high impedance while nevertheless achieving short start-up time. The resistor value is preferably much greater than 5MΩ, e.g., at least 10MΩ or 20MΩ, or 30MΩ, preferably at least about 40MΩ and most preferably at least about 50MΩ, e.g., 54MΩ. In embodiments having such resistor values, the resistor value may further be less than about 100MΩ.

The resistor may be connected to an input rail (VH+), e.g., an unrectified AC mains input or a rectified mains rail having a DC voltage of, e.g., approximately 150V or 340V, and the current amplified by means of the power switch (Q1) during the start-up/bootstrap period before the controller is activated. Alternatively, the resistor may be connected to the power switch side of the primary winding. Advantageously, the resistor is connected to bleed current directly or indirectly from the input rail.

Thus, an embodiment using the above current amplifier may both allow use of a high value start-up resistor (Rht1) and a high start-up current to rapidly charge the controller power supply capacitor (Cdd). Such an advantage may particularly be achieved by means of the passive circuit in the form of at least a passive circuit element (Dst) that allows charging of the controller power supply capacitor (Cdd) by the amplified current, but which may substantially inhibit current flow off the charged terminal of the controller power supply capacitor towards a reference voltage such as ground. Such a passive circuit element (Dst) may comprise a rectifier, e.g., a diode. References throughout this specification relating to an element conducting current ‘towards’ a particular circuit feature may encompass the current being conducted to the feature either by conduction through the element and directly to the feature or by conduction through the element and via other, intervening elements coupled between the element and feature. Similarly, references throughout this specification relating to current/charge/power ‘derived’ from an element may mean that the current/charge/power is sourced directly from the element or indirectly via intervening circuit elements.

Conveniently, the SMPC may comprise an integrated circuit (IC) such that the passive circuit may at least comprise at least one passive circuit element in the form of an electrostatic discharge protection diode of said IC. A low component count and/or low cost and/or easily manufacturable SMPS may then be achievable. In particular, if the controller is provided as a self-contained unit, e.g., as an IC, the power supply capacitor may be either internal or external to the controller. Furthermore, if the controller comprises a controller integrated circuit (IC), at least one electrostatic discharge protection diode of the controller IC may be used as the passive circuit.

Wasted power in an SMPS, which may otherwise be around 10 mW, is particularly disadvantageous in unloaded (or standby) conditions, i.e., when there is no external load on the SMPS. It is particularly advantageous to avoid power wastage where primary side sensing is used to control the SMPS output, e.g., where switching of the power switch continues even when no external load is present (a dummy load may be used in this scenario).

Even though the first aspect uses a current amplifier, an embodiment may nevertheless prevent current amplified by the current amplifier being continuously passed to the controller power supply capacitor (Cdd) during steady state operation, i.e., normal running, of the controller.

Regarding periods when the power switch is not connected to ground by the controller, i.e., the power switch is off, the voltage on the emitter of the power switch may be clamped at a predetermined voltage, e.g., 3.3V, via the passive circuit (e.g., Dst), one terminal of which may be connected to a stiff voltage source such as the controller supply input capacitor (Cdd). In this case, current bled from the internal power supply into the input of a current amplifier may be insufficient to turn the power switch on.

Further in this regard, in a further aspect of the invention, there is provided a method of operating a switch mode power converter, comprising the above described bootstrapping method and comprising none or any combination of the above optional features of the first aspect, and further comprising operating of said power supply with on-off switching of said power switch during a standby mode of said SMPC, and wherein, when said power switch is off, said current amplifier is substantially switched off.

Thus, during a standby mode of said SMPC, the power supply may continue to operate with on-off switching of the power switch such that, when the power switch is off, the current amplifier is substantially switched off. (This may be further advantageous where ringing occurs when the controller switches the power switch off. Ringing may occur due to residual capacitance between the power switch emitter and ground, and may occur when the controller control switch (S1) has just switched to its open state, i.e. off).

Regarding periods when the power switch is connected to ground by the controller, the power switch may be configured to be heavily on, e.g., saturated. For example, the power switch may be configured to be heavily on when the above switch element (S1) of the controller is in the closed state, so that the emitter current of the power switch is dominated by the collector current from the transformer and the power switch base current is not amplified.

The prevention or minimisation of amplified current passed to the controller power supply capacitor (Cdd) during normal running of the controller may thus be particularly achievable by configuring the passive inhibiting circuit element to ensure that the current from the input rail through the high impedance (e.g., 10-50MΩ) of the resistor is not amplified when the controller is active. Furthermore, prevention of the power switch turning on when the power switch is not connected to ground by the controller may further advantageously be achievable using clamping and/or limiting of a voltage on the control terminal, e.g., base, of the power switch, as described in more detail below.

In an embodiment wherein a bipolar transistor is used as the power switch, and particularly advantageously where the power supply continues to operate as described in the paragraph above, a voltage on said base terminal may be passively clamped when the bipolar transistor power switch is off such that a voltage drop across said transistor is less than a turn-on threshold.

Such clamping may prevent turning on of the power switch when the controller is attempting to maintain the power switch off. One way of achieving such clamping is via a passive circuit element such as a resistor (e.g., Rbase) connected at one terminal to a predetermined voltage. Such a predetermined voltage may for example be provided by the voltage on a second capacitor (Csw), which provides a stiff voltage source and may be charged from the auxiliary rail via a passive circuit element such as the third rectifier (Ddd) mentioned below.

At the same time, the emitter of the power switch may be passively clamped by the passive circuit (Dst) such as a diode connected at one terminal to the controller supply input capacitor (Cdd), particularly when a control switch (S1) of the controller is off, i.e., open. Thus, circuitry may be configured to provide a base-emitter voltage of the power switch (Q1) such that the power switch (Q1) remains off when the controller is attempting to maintain the power switch off.

Where a bipolar transistor is used as the power switch, a voltage on the base connection of the bipolar transistor power switch may be limited when the power switch is off to maintain the bipolar transistor power switch off. Such limiting may be achievable for example by means of a diode, or by a switch element (Qsw) as further described below.

The base connection of the bipolar transistor power switch may particularly advantageously be clamped using a switching device such that the said clamping of said base is selectively applied when the controller is operational to control the switching device to maintain the bipolar transistor power switch off when controlled off by the controller despite the bleeding of the current from the internal power supply into said base connection.

Where such selective clamping is implemented, the clamping of said base connection of said bipolar transistor power switch using a switching device may comprise coupling said switching device between said base connection and a regulated voltage and controlling said switching of said switching device to switch said device on to clamp said base when said controller is operating to switch said device on and off. The regulated voltage may be provided by means of a regulator (e.g., a 3.3V regulator) internal or external to the controller for regulating the voltage of the input supply (Vdd) to the controller. Such selective clamping may prevent gradual rising of a voltage at a node (‘X’—see below and FIG. 2) coupled to the base, which may otherwise turn on the power switch even when the power switch has been turned off by the controller. Such rising is illustrated in FIG. 4.

In any embodiment of the first aspect, the controller, whether it is an IC or not, may be substantially inoperative to control the power switch until a threshold voltage of the power supply to the controller is reached. Such a feature of a controller is particularly advantageous for achieving brown-out protection at an accurately predetermined input rail voltage, using methods and brownout protection circuitry described below. When the controller is substantially inoperative, the controller may draw less than, e.g. about 1 mA, and a switch element of the controller for connecting the power switch to ground may remain off, i.e., open. Such a threshold voltage may be the above threshold operating voltage.

Particularly advantageously with regard to brown-out, where the controller is substantially inoperative to control said power switch until a threshold voltage of said power supply to said controller is reached, an embodiment of the first aspect may further comprise setting a start-up voltage for said internal power supply for operating switching of said controller by controlling a voltage on said base terminal of said bipolar transistor dependent on said voltage of said internal power supply.

Other aspects of the invention respectively comprise apparatuses corresponding to the above method embodiments.

According to a second aspect of the present invention, there is provided a bootstrap circuit for a switch mode power supply, the switch mode power supply for converting a voltage of an input power rail, the switch mode power supply comprising: a transformer having a primary winding coupled to receive power derived from said input power rail; an auxiliary power supply; an internal power supply; a bipolar power switch; a controller having a supply input and a control switch connected in series with the emitter of the bipolar power switch; a reservoir capacitor configured to receive current from the auxiliary power supply and to determine voltage on the supply input of the controller, the bootstrap circuit comprising: a current bleed impedance to bleed current from the internal power supply; circuitry to deliver current from the internal power supply via the current bleed impedance to the base of the power switch such that the power switch is operable to amplify the current delivered from the internal power supply; a passive circuit to provide the amplified current to the reservoir capacitor; and the passive circuit further to substantially block reverse current flow from the supply input to the emitter of the power switch.

Thus, the second aspect may broadly be considered as a method corresponding to the first aspect and may have none or any combination of method features corresponding to the above optional features of the first aspect.

The internal power supply may be to supply power derived from the input power rail. The above optional features of the internal power supply of the first aspect regarding the supply being AC or DC and derived with or without rectification, e.g., from the AC mains, apply further to the internal power supply of the second aspect. For example, the internal power supply of the second aspect may be a power line or circuitry directly connected the input power rail. Alternatively, the internal power supply may be powered from another internal or external source, e.g., battery, and may comprise such an internal source.

In particular, and as described above, the auxiliary power supply may be internal to the SMPC, and thus may comprise an auxiliary winding of the transformer.

In any embodiment of the second aspect, the bootstrap circuit may further comprise any element of the switch mode power supply, e.g., the bipolar power switch and/or the controller and/or the reservoir capacitor.

It is further noted that the transformer in any embodiment may be an auto transformer, e.g., a tapped transformer, wherein said primary, secondary, and optionally auxiliary, windings are defined by a single winding of said transformer.

The power switch may comprise various types of current amplifier device. For example, the bipolar power switch may be a pnp or npn BJT, IGBJT, a thyristor or any other suitable three-terminal bipolar switching device known to the skilled person.

Other aspects may be substantially identical to the above second aspect, but may replace the bipolar power switch with, e.g., a relay. Further in this regard, the bipolar power switch may be replaced by a FET (e.g., MOSFET, IGFET, JFET, etc.) in other aspects otherwise identical to the second aspect. Even when a FET is used as a voltage amplifier, current (albeit small) may nevertheless flow to and from the gate terminal of the FET to charge/discharge the gate capacitance to obtain the corresponding gate voltage, thus varying the drain-source current. Thus, the FET can be viewed as a ‘current amplifier’, the drain-source current being considered as an amplified version of the gate current.

In any embodiment of the second aspect, the passive circuit may comprise a rectifier such as a diode. In particular, where the switched mode power supply has an integrated circuit such as the controller in the form of an IC, the passive circuit may at least comprise a passive circuit element (Dst) in the form of an electrostatic discharge protection diode integral to the integrated circuit. Thus, where the IC is comprised of, in particular, low voltage (e.g., 3.3V) IC technology having built-in electrostatic discharge protection diodes on input terminals as standard, the present invention advantageously may have a low component count and/or be provided at low cost.

Furthermore in any embodiment of the second aspect, a first capacitor (Cdd) may be provided to receive current from the auxiliary power supply and to determine voltage on the supply input (Vdd) of the controller. This may stabilise the voltage on the Vdd input during normal running, so improving reliability.

For high-frequency operation where the power switch needs to be switched at a rapid rate, e.g., at higher loads, it may be advantageous to remove charge from the power switch input terminal, e.g., base, in a relatively short time period. This may particularly be the case where the power switch is a bipolar transistor, since the base terminal thereof may store significant charge when switched on. (As noted above and below, the power switch may be turned on heavily in embodiments).

In view of this, any embodiment of the second aspect may incorporate a second rectifier and a second capacitor, said second rectifier configured to allow charge derived from the base of the power switch to pass toward the second capacitor. Such charge conduction may occur when the second rectifier (Dbase) is forward-biased due to the voltage on the base of the power switch (Q1). The second rectifier (Dbase) may be a diode. (This rectifier is referred to as ‘second’ merely in view of the passive circuit that may be a first rectifier).

In an embodiment configured such that the bipolar power switch is heavily on when in the ‘on’ state, the current through the emitter of the power switch is dominated by the transformer primary winding current rather than by the amplified base current of the power switch. This may further advantageously ensure that the current derived from the current bleed impedance (Rht1) is not continuously amplified during the normal running mode of the controller.

In any embodiment of the second aspect, a second impedance may be connected to conduct current derived from the base of the power switch. The second impedance may be a resistor (Rbase) and/or may be connected in parallel with the second rectifier (Dbase). Such an impedance may provide a pathway for supplying charge to turn the power switch (Q1) on, and further to clamp the voltage on the base of the power switch so maintaining the power switch (Q1) off when the power switch has been turned off by the controller.

The current bleed impedance may have a terminal connected to a terminal of the second impedance. In this way, the current bleed impedance (Rht1) may be connected to the base of the power switch via the second impedance (Rbase). Alternatively, a terminal of the current bleed impedance (Rht1) may be connected directly to the base terminal of the power switch. In either case, another terminal of the current bleed impedance (Rht1) may be connected directly or indirectly to the input power rail (VH+). Moreover, current bled from the input power rail (VH+) by the current bleed impedance (Rht1) may still flow directly or indirectly into the input terminal (e.g., base) of the bipolar power switch (Q1).

In more detail, where a terminal of the current bleed impedance (Rht1) is connected to the input power rail (VH+), another terminal of the current bleed impedance (Rht1) may be connected to the input terminal, e.g., base, of the power switch (Q1) via the second impedance (Rbase). This may be achievable, for example, by connecting the lower terminal of Rht1 in FIG. 2 to Node X, rather than directly to the input terminal of the power switch Q1 as shown. Where the second impedance has a low impedance (e.g., resistance of about 100Ω) relative to the impedance value of the current bleed impedance (e.g., resistance of about 10 MΩ-50MΩ or greater), the presence of the second impedance in the current flow path from the current bleed impedance to the input terminal may make a relatively insignificant difference to the delivery of current to the input terminal.

In any above embodiment of the second aspect using the second rectifier (Dbase), it may be found that a voltage on a node (‘X’—see FIG. 2) corresponding to the cathode of that diode may gradually rise over a plurality of cycles of switching of the power switch, as shown in FIG. 4. The rise may occur due to gradual charging of the second capacitor (Csw) with a current of, e.g., 10 uA, derived from the input rail (VH+) via the current bleed impedance (Rht1) when the power switch (Q1) is off. The gradual rise may have the consequence that the voltage on the second capacitor (Csw), and therefore that on the input terminal of the power switch Q1, creeps up and turns the power switch (Q1) on undesirably, i.e., even when the controller has turned off the power switch. This is particularly the case if the power switch is run at a relatively low frequency and/or with short on-time such that the power switch is switched off for a greater proportion of time.

To reduce instances of undesired turning-on of the power switch, it may be considered to not operate below a certain frequency, to make the second capacitor (Csw) a large capacitance, or to employ a yet higher value current bleed impedance (Rht1). However, more advantageously, the different techniques described below may clamp or limit the node (‘X’—see FIG. 2) voltage.

The following describes a first technique applicable in any embodiment of the second aspect, and which is particularly applicable to a switch mode power converter that switches at relatively high frequencies.

An impedance such as a third rectifier may be configured to allow current derived from said auxiliary power supply to pass toward the second capacitor and to substantially block reverse current from the second capacitor to the auxiliary power supply. Such a third rectifier may be a diode (Ddd) as shown in FIG. 2. A cathode terminal of the rectifier (Ddd) may be connected to a cathode terminal of the second rectifier (Dbase).

Furthermore, an auxiliary capacitor may be provided to receive current from the auxiliary power supply, the auxiliary capacitor preferably being configured to determine voltage on the anode terminal of said third rectifier.

Furthermore, an auxiliary rectifier (Daux) may be provided in any embodiment to allow current derived from the auxiliary power supply to pass toward the reservoir capacitor (Cdd). (The auxiliary rectifier may further allow such derived current to flow toward the above auxiliary capacitor Caux, e.g., as shown in the embodiment of FIG. 5). The auxiliary rectifier (Daux) is preferably being configured to substantially block reverse current derived from the reservoir capacitor (Cdd) and/or the auxiliary capacitor to the auxiliary power supply.

The controller of any embodiment may comprise circuitry to regulate the voltage on the supply input (Vdd) of the controller when the controller is operating. For example, such circuitry may comprise a voltage regulator that, when active, maintains the voltage on the supply input at 3.3V. Such a regulator may be activated by a sleep latch that responds to the presence of, e.g., 4V, on an input to the controller. Thus, for example, taking into account forward voltages of the diode (Dst) and the power switch (Q1) base-emitter junction, the controller may enter normal/running operation when the base of the power switch reaches 5.2V. In other words, the base voltage of the power switch may need to be, e.g., 5.2V to initially turn the power switch on.

Where an SMPC may be expected to switch at relatively low frequencies, it may be advantageous to implement in an embodiment of the second aspect a different, second technique illustrated by way of example in FIG. 5.

Generally speaking, the second technique replaces or supplements the third rectifier Ddd of the first technique with a switch element (Qsw). The third rectifier may comprise such a switch element. For example, the third rectifier (Ddd), which may be in the form of a diode, may be replaced by a switch element (Qsw) or a switch element may be connected in parallel with the third rectifier (Ddd). The switch element (Qsw) may be a bipolar transistor such as an npn or pnp transistor, or may be a field effect transistor, e.g., MOSFET or JFET.

As described above, the controller of an embodiment implementing the second technique may have circuitry to regulate the voltage on the supply input of the controller when the controller is awake, i.e., operating normally. Furthermore, the controller may have a sleep latch as described above to activate the regulator when voltage on the supply input to the controller reaches or exceeds a threshold.

The provision of a regulator and sleep latch is particularly advantageous in combination with the above second technique, as further described below.

Similarly, the above provision of the above auxiliary capacitor (Caux) is particularly advantageous in combination with the second technique, as described below.

As described previously, a regulator may be used to regulate the voltage on the controller supply input Vdd when the controller is in the normal, running state. The voltage on the node (‘X’) may thus advantageously be clamped by means of such a regulator, which may be internal or external to the controller.

The switch element (Qsw) may be configured to turn on only when a voltage derived from the auxiliary power supply, e.g., auxiliary winding, is significantly (e.g., more than 1V) above the voltage on the controller supply input (Vdd).

Specifically, the switch element may be configured to be switched on dependent on a voltage difference between said voltage on said auxiliary capacitor and voltage on said supply input to said controller, wherein said switch element is configured to conduct current derived from a cathode terminal of said second rectifier when the switch element is switched on.

For example, where the switch element comprises a bipolar transistor, an impedance may be configured to bleed current to the base of said switch element dependent on said voltage on the auxiliary capacitor. Such an impedance may be a resistor (Rsw). Furthermore, an impedance may be connected between the emitter or collector of the switch element and the base of said switch element to provide said voltage difference. The latter impedance may be a resistor (Rdd).

In an embodiment described above comprising the reservoir, second and auxiliary capacitors (Cdd, Csw and Caux, e.g., 3.2 uF, 470 nF, luF, respectively), the voltage on the second capacitor (Csw) may rise at a predetermined voltage difference ahead of the voltage on the reservoir capacitor (Cdd), e.g., about 1.2V ahead. (The bootstrap rectifier, e.g., diode (Dst) and the base-emitter junction of the bipolar power switch may determine the predetermined voltage difference). Some of the start-up current, which is bled through the power switch (Q1) and bootstrap rectifier (Dst), may be diverted from the reservoir capacitor (Cdd) through an impedance (Rdd) to charge the auxiliary capacitor (Caux).

Depending on the proportion of the start-up current diverted, the voltage on the auxiliary capacitance (Caux) may thus be the slowest rising of these voltages on the reservoir, second and auxiliary capacitors (Cdd, Csw and Caux, respectively). Thus, the voltage on the auxiliary capacitor (Caux) may be configured to reach a predetermined voltage after the voltage on the supply input (Vdd) reaches a predetermined voltage during start-up.

A controller having a sleep latch may wake up when a predetermined voltage is reached or exceeded on the controller supply input (Vdd), e.g., 4V. The sleep latch may then activate the switching of controller control switch S1. In turn, and considering the auxiliary power supply as comprising an auxiliary winding as above, the activation of the power switch Q1 may cause current to flow through the primary winding, inducing a voltage on the auxiliary winding. This in turn may push the voltage on the auxiliary capacitor (Caux) up rapidly. Thus, the voltage on the auxiliary capacitance (Caux) may initially rise substantially linearly and then be pushed rapidly to a higher voltage of, e.g., 7V when the sleep latch wakes the controller up to be in normal running mode. The switch element (Qsw) may switch on only when the voltage on the auxiliary capacitance (Caux) has risen significantly above the voltage on the reservoir capacitance (Cdd).

In this way, it may be advantageously achievable that the switch element (Qsw) turns on to leak charge from the node (‘X’—see FIG. 5) only when the controller is in normal running mode. In other words, using the second technique, charge on the second capacitor (Csw) may be slowly leaked away directly from the base of the power switch or from a node (‘X’—see FIG. 5) between impedances such as the second impedance (Rbase) and the reservoir capacitance (Cdd), by means of the switch element (Qsw) when the controller is in normal running mode. In this state, turning on of the switch element (Qsw) may advantageously prevent voltage on the node (‘X’) rising over many cycles. This may advantageously reduce power wastage by the power switch (Q1).

The second technique may be particularly advantageous where primary side sensing is used. In primary side sensing, voltage and/or current on the primary side (e.g., on the primary winding or on a terminal of the power switch) may be sensed to allow load-dependent control of switching of the power switch. Such sensing may exploit the influence of secondary side signals, e.g., load current, on the primary side signal. It is therefore advantageous in a primary-side sensing power converter to maintain switching of the power switch even when no external load is connected. Therefore, a dummy load (e.g., 5 KΩ) may be provided to remain connected to the converter output even when no external load is present. For driving such low loads, a relatively low frequency (e.g., 1 kHz) may be used compared to a higher frequency (e.g., 40-60 kHz) used for normal, external loads. Furthermore, pulses driving the power switch may be shortened when power is being supplied to a low and/or dummy load.

Further in relation to undesirable turning on of the power switch (Q1), passive clamping of the base of the power switch (Q1) further advantageously reduces effects, which may be due to changes in the base-emitter voltage of the power switch caused by ringing on the emitter-drive (ED) terminal of the controller when the control switch S1 is opened.

Any embodiment of the second aspect may further comprise brownout protection circuitry, the controller starting operating when the supply input reaches or exceeds a first threshold, the brownout protection circuitry to cause said voltage on said supply input to reach or exceed said first threshold when the voltage on the input power rail reaches or exceeds a second threshold, the brownout protection circuitry comprising: a third impedance configured to conduct current towards a reference voltage line; the current bleed impedance connected to deliver current to the third impedance and to the base of the power switch; the current bleed impedance and the third impedance (Rht2) connected such that the ratio of a value of the current bleed impedance to a value of the third impedance determines the second threshold.

Such an embodiment may provide partial or complete brownout protection in the event of input power (e.g., AC mains) loss or reduction, for example by allowing controlled start-up after such loss.

In particular, such brownout protection circuitry may further comprise at least one rectifier (Dht), e.g., one or more diodes, connected in series with the third impedance to allow said current bled to said reference voltage line to flow via said third impedance such that the second threshold is further determined by forward voltage of the at least one rectifier. Particularly advantageously, at least one diode may allow the variation of total forward voltage drop of the at least one diode under certain conditions, e.g., time or temperature, to be substantially equal to variation of the voltage drop of the path from the drive terminal of the power switch to the supply input (Vdd) of the controller under the same conditions. For example, a number of diodes may be provided in series matching the number of semiconductor pn junctions in the path. Thus, in an embodiment, two diodes may be provided to compensate for variation in voltage drop across the base-emitter junction of the bipolar transistor power switch and the passive circuit (Dst).

According to a third aspect of the present invention, there is provided a controller for a switch mode voltage converter comprising a power switch, the controller comprising a control switch to switch current flow though said power switch on and off and the bootstrap circuit of any embodiment above of the second aspect.

According to a fourth aspect of the present invention, there is provided a switch mode converter, e.g., a switch mode flyback or forward converter, comprising the bootstrap circuit of any embodiment above of the second aspect. Such a converter may be a resonant discontinuous forward converter (RDFC).

According to a fifth aspect of the present invention, there is provided a bootstrap circuit for a switched mode power supply, which may be similar to the second aspect but wherein the power switch is a field effect transistor, e.g., MOSFET, JFET, IGFET, etc. Thus, any combination of the optional features of the second aspect may apply to the fifth aspect, taking into account the use of a field effect transistor as the power switch. Current amplification may still occur using such a transistor, albeit on a different scale in comparison to when using a bipolar transistor as the power switch (Q1). Nevertheless, such a circuit may advantageously operate to reduce power wastage and/or increase start-up time.

Thus, the fifth aspect provides a bootstrap circuit for a switch mode power supply, the switch mode power supply for converting a voltage of an input power rail, the switch mode power supply comprising: a transformer having a primary winding coupled to receive power derived from said input power rail; an auxiliary power supply; an internal power supply; a field effect power switch; a controller having a supply input and a control switch connected in series with the source or drain of the field effect power switch; and a reservoir capacitor configured to receive current from the auxiliary power supply and to determine voltage on the supply input of the controller, the bootstrap circuit comprising: a current bleed impedance connected to the internal power supply; circuitry to deliver current from the internal power supply via the current bleed impedance to the gate of the power switch such that the power switch is operable to amplify the current delivered from the internal power supply; a passive circuit configured to provide the amplified current to the reservoir capacitor; and the passive circuit further configured to substantially block reverse current flow from the supply input to the source of the power switch.

Thus, the fifth aspect may broadly be considered as corresponding to the second aspect except in features relating to the replacement of the bipolar power switch with a FET switch and may have none or any combination of the above optional features of the second aspect, taking into account the use of the FET.

In particular, and as described above, the auxiliary power supply may be internal to the SMPC, and thus may comprise an auxiliary winding of the transformer.

Embodiments of the first to fifth aspects above use a passive circuit, which may comprise a passive circuit element such as a rectifier, e.g. a diode (Dst), to provide amplified current to the controller supply input (Vdd). However, other types of component may be used additionally or alternatively to such a passive circuit element. Use of a passive circuit is particularly advantageous for avoiding complex control of numerous control switches for reducing power wastage.

Other aspects of the invention respectively comprise methods corresponding to the above bootstrap circuits, controller, switch mode flyback converter and switch mode forward converter.

Preferred embodiments are defined in the appended dependent claims.

### BRIEF DESCRIPTION OF THE DRAWINGS

For a better understanding of the invention and to show how the same may be carried into effect, reference will now be made, by way of example, to the accompanying drawings, in which:

FIG. 1 is a simplified schematic circuit diagram of an SMPS;

FIG. 2 is a simplified schematic circuit diagram of an embodiment of an SMPS with a bootstrap circuit of an embodiment;

FIG. 3 is a schematic diagram showing bootstrap and brown-out protection components as part of a power supply unit of an embodiment; and

FIG. 4 shows how the voltage on the base terminal of the main transistor Q1 of FIG. 2 may vary with time.

FIG. 5 shows an alternative scheme to avoid the voltage at node X rising over many cycles.

### DETAILED DESCRIPTION OF PREFERRED EMBODIMENTS

The proposed schemes are particularly applicable to an SMPS employing an emitter-(or source-) switched power transistor and merely less so to a base- (or gate-) driven arrangement.

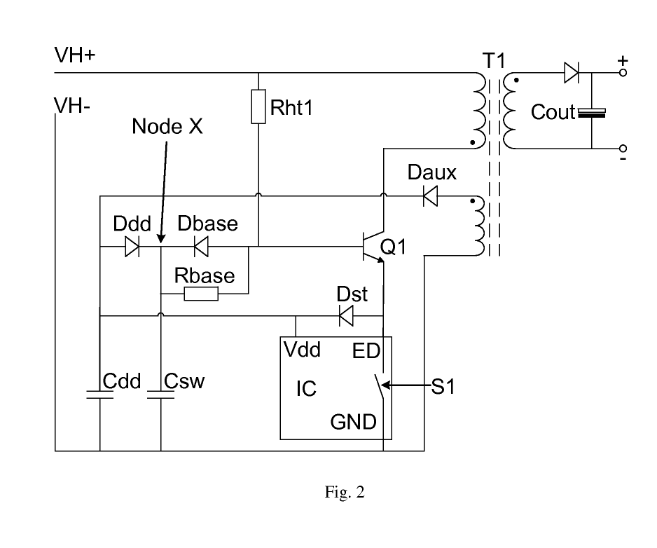

An embodiment of a bootstrap scheme employs the gain of a power transistor Q1 to provide an amplified start-up current to an SMPS controller (e.g. control IC), this allowing a very high-valued start-up resistor Rht1 to be used. This, and the prevention of such amplified Q1 start-up current from flowing after the start-up period, reduces the associated power loss. The scheme is illustrated below in the simplified circuit diagram of FIG. 2.

Embodiments may advantageously achieve either or both of the following:
1) a fast start-up for a circuit (e.g. Switched-Mode Power Supply) with minimal power wastage; and/or
2) a precise input voltage threshold for a circuit (e.g. Switched-mode Power Supply) to start up.

Furthermore, particular embodiments of configuring the start-up circuit may advantageously achieve two useful features, i.e., fast efficient start-up and precise brown-out protection, with minimal cost impact.

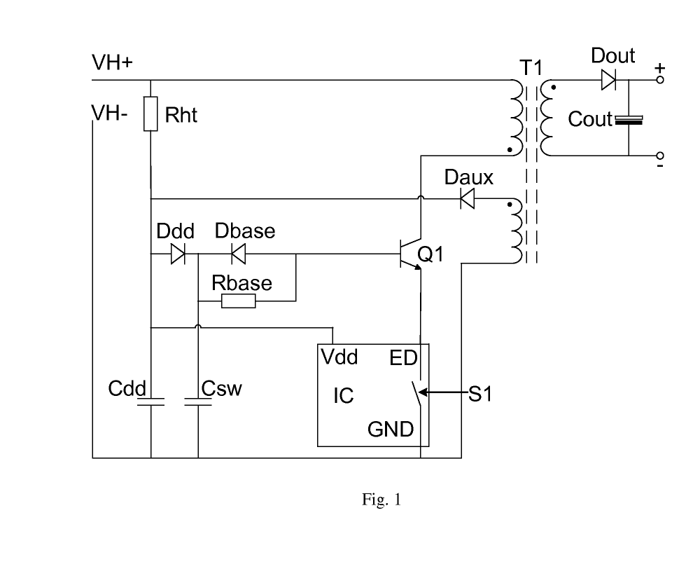

There are two particularly significant changes in the circuit of FIG. 2 from that of FIG. 1:
the start-up resistor Rht1 connects the high voltage rectified mains rail VH+ to the base terminal of power transistor Q1, rather than to the node common to the Vdd terminal of the IC and the reservoir capacitor Cdd; and
a new diode Dst connects the emitter terminal of the power transistor Q1 to the Vdd terminal of the controller IC and thus to the reservoir capacitor Cdd.

Start-up current flows from the power rail VH+ through the resistor Rht1, and is then amplified by power switch Q1 and flows from the latter's emitter terminal through diode Dst to the node common to the controller IC's Vdd terminal and the reservoir capacitor Cdd. An advantage of this technique is that the current passing through the start-up resistor Rht1 can be greatly reduced by the current amplification of Q1, which may mean that the power loss in this resistor is greatly reduced compared to previous configurations. For illustration, the current gain h_{fe} of power switch Q1 and hence the power loss reduction factor during start-up may be approximately 25. Wasteful Rht1 current during start-up is therefore greatly reduced from that in the circuit of FIG. 1.

Once the power supply has begun operating normally, the main transistor Q1 is switched on and off by the controller switch S1. Current amplification of the current through Rht1 is advantageously reduced or prevented when Q1 is switched off by the switch S1 of the controller IC, thereby minimising standing power losses when the power supply is running.

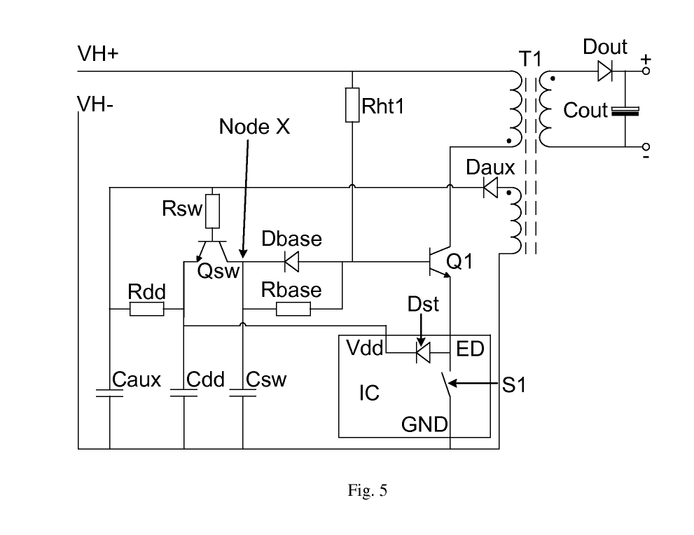

Diode Dst provides a path for start-up current to Vdd from the Q1 emitter terminal. Although a discrete Dst component is shown in FIG. 2, it is particularly advantageous to use diode(s) internal to the IC for this rectification. Internal electrostatic discharge (ESD) protection diodes of an IC, for example, may be suitable and eliminate the requirement for additional components external to the IC. Such a scheme is shown schematically in FIG. 5. A number of diodes Dst in series may be employed to achieve a suitable voltage drop between the ED and Vdd terminals of the IC, depending on IC design parameters where at least one of the diodes is an ESD protection diode. This may be advantageous for particular Vdd and other IC voltages of the controller, for example those occurring on ICs fabricated by a higher voltage process. For example, such IC voltages may be different for 3.3V and 5V and higher voltage processes, e.g., 10V or more.

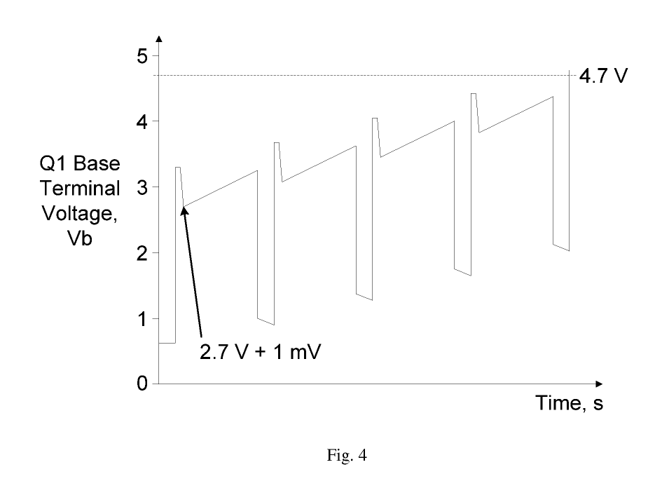

One disadvantage of the circuit of FIG. 2 is that the voltage on the capacitor Csw may rise over many cycles, such that the main transistor is eventually turned on undesirably and wastes power. This is illustrated by FIG. 4 that shows how the base voltage Vb of the main transistor Q1 of FIG. 2 may vary with time.

The detailed explanation of FIGS. 2 and 4 in the following paragraphs is provided merely for purposes of example only. In particular, the values of components, currents and voltages are exemplary and are provided merely to aid understanding. For example, the forward voltage of a pn junction in, e.g., Dbase, Dst or the base-emitter junction of Q1 may be 0.6V or 0.7V.

When the controller is running, the voltage Vdd may be regulated so that the voltage on the reservoir capacitor Cdd is held at a substantially constant voltage, e.g., 3.3V. Taking into account a 0.6V forward bias voltage across the diode Ddd, the voltage at node X may be 2.7V. However, current Iht through the resistor Rht1 may charge the capacitor Csw through the resistor Rbase. If Iht=10 uA and Rbase=100R, the voltage across Rbase due to Iht is 1 mV=10 uA*100R. While this may generally be insufficient to turn the diode Dbase on, the current Iht may cause the voltage at node X to rise over many cycles. While the emitter of the main switch Q1 is held at Vdd+V(Dst)=3.3V+0.6V (due to the connection to the regulated voltage Vdd through the diode Dst), the base-emitter voltage of the main switch may thus gradually rise, eventually turning the main transistor Q1 on when the base voltage Vb of Q1 reaches Vdd+V(Dst)+Vbe(on)=3.3V+2*0.6V≈4.5-4.7V.

As shown in FIG. 4, when Q1 is on, the base voltage Vb of Q1 is determined by the emitter connection to ground through S1 and the on-state voltage of the Q1 base-emitter junction, i.e., 0.6-0.7V. When S1 turns off, the Q1 base voltage Vb changes briefly from 0.6-0.7V to 3.3V, while the Q1 turn-off collector current Ic(sw) flows through forward-biased diode Dbase. Once the base of Q1 has discharged, e.g., after a turn-off delay of 200 ns, the base voltage Vb of Q1 reduces to 2.7V+1 mV, the 1 mV resulting from flow of Iht through Rbase. This current through Rbase charges Csw, and may cause the voltage at node X to increase until the time at which Q1 next switches on. The voltage at node X may decrease whilst Q1 is switched on because Csw delivers charge to the Q1 base-emitter junction via Rbase. However, much of this charge may be recovered by Csw when Q1 turn-off collector current Ic(sw) flows through forward-biased diode Dbase. If the net amount of charge delivered from Csw to the base of Q1 over one switching cycle is less than the sum of the charge recovered via Dbase and Rbase and that flowing through Rht over the same period, the voltages at node X and at the base of Q1 may tend to increase over many cycles. For illustration, over a time of dt=dV*Csw/I=1.2V*470 nF/10 uA≈60 ms, the base voltage Vb may have risen sufficiently for Q1 to turn on.

In particular, the current Iht may charge Csw sufficiently to turn the main transistor Q1 on undesirably when Q1 is being switched by the controller switch S1 at a low frequency. At such a frequency, the above charging of Csw may mean that substantially no net current flows out of the Q1 base when Q1 is turned off. Consequently, the voltage on node X may rise over many cycles.

Therefore, it is advantageous to extract charge from node X.

FIG. 5 shows an alternative scheme to advantageously avoid the voltage at node X of FIG. 2 rising over many cycles. Such a scheme may advantageously stop the base voltage Vb approaching Vdd+V(Dst)+Vbe(on)=3.3V+2*0.6V≈4.5-4.7V. This may be achieved by replacing the diode Ddd with a switch transistor Qsw to extract current from capacitor Csw to the capacitor Cdd, which is regulated. This may occur when the controller is running and the voltage Vdd is thus being regulated. In FIG. 5, Ddd is replaced by a switch Qsw. Alternatively, a switch Qsw may be placed across Ddd. The switch is configured to close when the controller is running and the voltage Vdd is thus being regulated.

In contrast, when the SMPS is bootstrapping, the voltage on the auxiliary line (Aux) may not be significantly higher than the voltage Vdd on the controller input, so that Qsw remains off.

More specifically, when the SMPS is bootstrapping, the capacitor Csw charges via Rbase and reservoir capacitance Cdd charges via diode Dst. In particular, the voltage on reservoir capacitance Cdd follows about 2*0.6V=1.2V behind the voltage on capacitor Csw, while the voltage on auxiliary capacitor Caux may rise more slowly than the voltage on reservoir capacitance Cdd, dependent on the proportion of start-up current that is diverted to Caux instead of passing to Cdd and further depending on the capacitance values of Cdd and Caux. As a result, the voltage on the auxiliary line (Aux) may rise more slowly than Vdd during start-up.

The controller may comprise a sleep latch and a regulator, e.g., a 3.3V Zener diode. The sleep latch may wake the regulator when Vdd reaches, e.g., 4V. In other words, the regulator may operate only when the controller has been woken up, i.e., is in normal running mode. When the switching of controller control switch S1 has been activated, the resulting activation of power switch Q1 may cause current to flow through the primary winding, thereby inducing a voltage on the auxiliary winding (considering the auxiliary power supply as comprising an auxiliary winding as described above). This in turn may push the voltage on the auxiliary capacitor (Caux) up rapidly to, e.g., 6-7V. In turn, the switch transistor Qsw is turned on. Thus, Dbase is connected through to the regulated voltage Vdd and the node X is advantageously prevented from rising.

Brown-out protection may be incorporated in power supplies to ensure that unpredictable behaviour is avoided when the incoming mains strays outside “normal” limits. In combination power supplies, a small auxiliary power supply may be used to provide the housekeeping rails for the main power supply blocks. It may be the responsibility of the auxiliary power supply to implement the brown-out protection for the whole PSU assembly. Brown-out protection may be implemented as described below.

The auxiliary power supply does not start up until the input voltage exceeds a predetermined voltage, Vstart. Once it has started up, the auxiliary power supply continues to run normally. If the input voltage subsequently drops below a predetermined low value Vstop (so that it becomes impossible to maintain the outputs of the auxiliary power supply at the correct voltages), the auxiliary power supply shuts down, and remains in the shutdown state until the input voltage is again restored, exceeding Vstart.

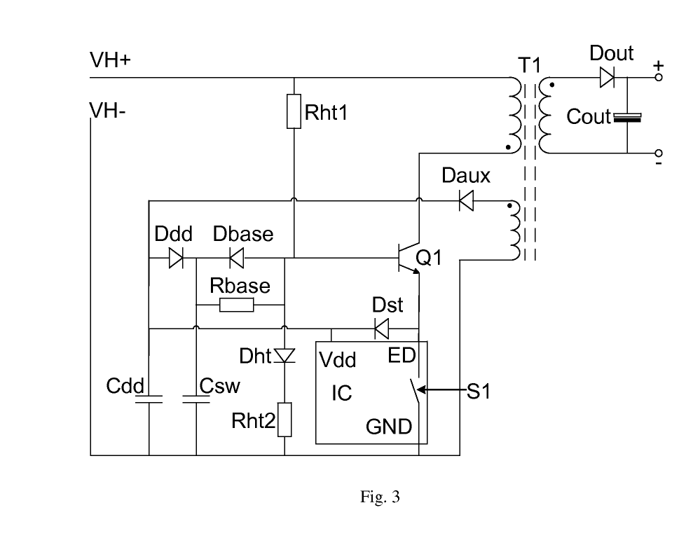

An embodiment described below advantageously provides a means of implementing a means of accurately setting the Vstart voltage, with a minimum of extra components in a SMPS. A schematic diagram of such an embodiment is shown in FIG. 3.

As described above in reference to the bootstrap circuit, resistor Rht1 provides a minimal current into the base of main switching transistor Q1. During start-up, the current gain of Q1, having a typical value of 25, causes a larger current to flow through Q1 (from collector to emitter). This current passes through the ED pin of the integrated circuit IC, through diode Dst, to be accumulated on Cdd. The controller IC is designed to start operating when the Vdd pin voltage exceeds a predetermined well-defined threshold Vddrun. By referring back from the Vdd pin, the start-up input voltage may be defined by the values of Rht1 and Rht2, where VDht is the forward voltage of diode(s) Dht:

Vstart=(Vddrun×(1+(Rht1/Rht2)))+VDht

For example, the controller may wake up when the voltage Vdd on the reservoir capacitor Cdd, and thus on the Vdd terminal of the controller, reaches 4V. This may correspond to a base voltage Vb on the main transistor Q1 of Vdd+V(Dst)+Vbe(on)=4V+2*0.6V≈5.2V, taking into account the forward voltages of the diode Dst and of the main transistor Q1 base-emitter junction. Vb=5.2V may occur when the rectified mains rail voltage VH+reaches a predetermined voltage over 100V, depending on the ratio of Rht1:Rht2. For example, the voltages across Rht1 and Rht2 may be 95V and 4V, respectively, if Rht1 is 2.4MΩ. and Rht2 is 100KΩ. The base voltage Vb is coupled to the Vdd terminal of the controller by current through the diode Dst and the main transistor Q1 base-emitter junction. These forward voltages may vary with operating conditions such as temperature and age. In an embodiment, two diodes Dht may be provided in series with Rht2 to compensate for such variation.

The above brown-out protection may be implemented similarly in an SMPS that does not comprise the bootstrapping circuit described above. However, in such an implementation it may be preferable to use lower resistances for Rht1 and Rht2, since the current Idd into the Vdd terminal of the controller may be required to be of the order of 3-7 uA.

It is further noted that embodiments of the invention may further be configured to reduce electromagnetic interference, i.e., to meet electromagnetic compatibility (EMC) requirements, by ensuring that the inductive elements of circuitry are balanced/symmetrical as far as possible. For example, the primary and/or secondary winding may be split, the primary winding having the power switch connected in series between the two split parts of the winding, the secondary winding having a diode between the two split parts of the winding.

For a better understanding of the invention, some example correspondences between abbreviations and terminology of this application are given below. However the invention is not limited to these particular correspondences, which are given merely by way of example:
Transformer Ti
Power switch Q1
Control switch S1
Supply input to the controller Vdd
Input power rail Vht+
Current bleed impedance Rht1
Third impedance Rht2
Passive circuit (element) Dst
Second rectifier Dbase
Third rectifier Ddd
Auxiliary rectifier Daux
Reservoir capacitor Cdd
Second capacitor Csw
Auxiliary capacitor Caux
Second impedance Rbase
First threshold Vddrun
Second threshold Vstart
Switch element Qsw

No doubt many other effective alternatives will occur to the skilled person. It will be understood that the invention is not limited to the described embodiments and encompasses modifications apparent to those skilled in the art lying within the spirit and scope of the claims appended hereto. For example, although the embodiments have been described in the context of a bipolar power switching transistor Q1, they are equally applicable to a SMPS employing other types of power transistor, such as a MOSFET or an IGBT. In the case of a MOSFET, a potential divider Rht1 and Rht2 allows a tap to provide the desired start-up voltage at the gate terminal of the power MOSFET. Further related embodiments are described in provisional application US61/183,720 (filing date Jun. 3, 2009) which is hereby incorporated by reference in its entirety.

Having described the invention, the following is claimed:

1. A method of bootstrapping a switch mode power converter (SMPC),
the SMPC having:
an input to receive power for said power converter;
an internal power supply derived from said power received at said input;
an output to provide a DC output voltage;
a power switch;
a controller to control said power switch, said controller having a threshold operating voltage;
a transformer having a primary winding and a secondary winding coupled between said input and said output;
said secondary winding being coupled to provide power for said DC output;
said primary winding being coupled in series with said power switch and coupled to receive power derived from said input to receive power;
an auxiliary power supply configured to provide a power supply to said controller;
the SMPC further comprising a controller power supply capacitor to store charge derived from said auxiliary power supply during operation of said SMPC for providing said power supply to said controller,
the method comprising:
bleeding current from said internal power supply into the input of a current amplifier; and
charging said controller power supply capacitor from a current output of said current amplifier via a passive circuit such that when a voltage of charge on said controller power supply capacitor derived from said auxiliary power supply is less than said threshold operating voltage said power supply to said controller is provided by said charging of said controller power supply capacitor from said current output of said current amplifier and wherein said passive circuit substantially inhibits current flow off said controller power supply capacitor towards ground.

2. A method as claimed in claim 1, wherein said auxiliary power supply comprises an auxiliary winding of said transformer.

3. A method as claimed in claim 1, wherein said current amplifier comprises said power switch, wherein said bleeding of said current from said internal power supply comprises bleeding current though a resistor into a control terminal of said power switch, and wherein said output of said current amplifier comprises a connection to a switched terminal of said power switch.

4. A method as claimed in claim 3, further comprising using a bipolar transistor for said power switch.

5. A method as claimed in claim 4, wherein said power switch comprises a bipolar transistor emitter switched device, the method further comprising using said controller to switch said emitter connection of said bipolar transistor power switch to ground.

6. A method as claimed in claim 1, wherein said controller comprises a controller IC, the method further comprising using an electrostatic discharge protection diode of said controller IC as an element of said passive circuit.

7. A method as claimed in claim 3, wherein said resistor has a value of at least about 10MΩ or at least about 20MΩ, preferably at least about 40MΩ and most preferably at least about 50MΩ.

8. A method as claimed in claim 1, wherein said controller is substantially inoperative to control said power switch until a threshold voltage of said power supply to said controller is reached, and wherein said controller draws less than 1 mA when substantially inoperative.

9. A method of operating a switch mode power converter, comprising the method of claim 1, further comprising operating of said power supply with on-off switching of said power switch during a standby mode of said SMPC, and wherein, when said power switch is off, said current amplifier is substantially switched off.

10. A method as claimed in claim 9 when dependent on claim 4, further comprising passively clamping a voltage on said base terminal when said bipolar transistor power switch is off such that a voltage drop across said transistor is less than a turn-on threshold.

11. A method as claimed in claim 4, further comprising limiting a voltage on said base connection of said bipolar transistor power switch when said power switch is off to maintain said bipolar transistor power switch off.

12. A method as claimed in claim 4, further comprising clamping said base connection of said bipolar transistor power switch using a switching device such that said clamping of said base is selectively applied when said controller is operational, to control said switching device to maintain said bipolar transistor power switch off when controlled off by said controller despite said bleeding of said current from said internal power supply into said base connection.

13. A method as claimed in claim 12, wherein said clamping said base connection of said bipolar transistor power switch using a switching device comprises coupling said switching device between said base connection and a regulated voltage and controlling said switching of said switching device to switch said switching device on to clamp said base when said controller is operating to switch said bipolar transistor power switch on and off.

14. A method as claimed in claim 1, wherein said passive circuit comprises a rectifier.

15. A method as claimed in claim 8, the method further comprising setting a start-up voltage for said internal power supply for operating switching of said controller by controlling a voltage on said base terminal of said bipolar transistor dependent on said voltage of said internal power supply.

16. A method as claimed in claim 2, wherein said transformer is an auto transformer, and wherein said primary, secondary and auxiliary windings are defined by a single winding of said transformer.

17. Bootstrap circuit for a switch mode power supply, the switch mode power supply for converting a voltage of an input power rail, the switch mode power supply comprising:
a transformer having a primary winding coupled to receive power derived from said input power rail;
an auxiliary power supply;
an internal power supply;
a bipolar power switch;
a controller having a supply input and a control switch connected in series with the emitter of the bipolar power switch;
a reservoir capacitor configured to receive current from the auxiliary power supply and to determine voltage on the supply input of the controller,
the bootstrap circuit comprising:
a current bleed impedance to bleed current from the internal power supply;
circuitry to deliver current from the internal power supply via the current bleed impedance to the base of the power switch such that the power switch is operable to amplify the current delivered from the internal power supply;
a passive circuit to provide the amplified current to the reservoir capacitor; and
the passive circuit further to substantially block reverse current flow from the supply input to the emitter of the power switch.

18. The bootstrap circuit of claim 17, wherein said passive circuit comprises a rectifier.

19. The bootstrap circuit of claim 17, wherein said switch mode power supply comprises an integrated circuit comprising said controller, and said passive circuit comprises an electrostatic discharge diode integral to said integrated circuit.

20. The bootstrap circuit of claim 17, the bootstrap circuitry further comprising:
a second rectifier and a second capacitor, said second rectifier configured to conduct charge derived from the base of the power switch towards the second capacitor.

21. The bootstrap circuit of claim 17, the bootstrap circuitry further comprising:
a second impedance connected to bleed current from the base of the power switch.

22. The bootstrap circuit of claim 21, wherein a terminal of the current bleed impedance is connected to the base of the power switch via the second impedance.

23. The bootstrap circuit of claim 20, further comprising a third rectifier configured to conduct current derived from said auxiliary power supply towards the second capacitor and to substantially block reverse current from the second capacitor to the auxiliary power supply.

24. The bootstrap circuit of claim 23, further comprising an auxiliary capacitor configured to receive current from the auxiliary power supply and to determine voltage on an anode terminal of said third rectifier.

25. The bootstrap circuit of claim 23, wherein said third rectifier comprises a switch element.

26. The bootstrap circuit of claim 25, wherein:
said switch element is configured to be switched on dependent on a voltage difference between said voltage on said auxiliary capacitor and voltage on said supply input to said controller; and
said switch element is configured to conduct current derived from a cathode terminal of said second rectifier when the switch element is switched on.

27. The bootstrap circuit of claim 26, wherein:
said voltage on said auxiliary capacitor is configured to reach a threshold voltage after said voltage on said supply input reaches a threshold voltage during start-up.

28. The bootstrap circuit of claim 17, wherein the controller comprises circuitry to regulate the voltage on the supply input of the controller when the controller is operating.

29. The bootstrap circuit of claim 27, wherein the controller comprises a sleep latch to activate the regulator when voltage on the supply input to the controller reaches or exceeds a threshold.

30. The bootstrap circuit of claim 17, further comprising brownout protection circuitry, the controller for starting operating when the supply input reaches or exceeds a first threshold, the brownout protection circuitry to cause said voltage on said supply input to reach or exceed said first threshold when the voltage on the input power rail reaches or exceeds a second threshold,
the brownout protection circuitry comprising:
a third impedance configured to conduct current towards a reference voltage line;
the current bleed impedance connected to deliver current to the third impedance and to the base of the power switch;
the current bleed impedance and the third impedance connected such that the ratio of a value of the current bleed impedance to a value of the third impedance determines the second threshold.

31. The bootstrap circuit of claim 30, the brownout protection circuitry further comprising:
at least one rectifier connected in series with the third impedance to allow said current bled to said reference voltage line to flow via said third impedance such that the second threshold is further determined by forward voltage of the at least one rectifier.

32. Controller for a switch mode voltage converter comprising a power switch, the controller comprising a control switch to switch current flow through said power switch on and off and the bootstrap circuit of claim 17.

33. Switch mode voltage converter comprising the bootstrap circuit of claim 17.

34. Bootstrap circuit for a switch mode power supply, the switch mode power supply for converting a voltage of an input power rail, the switch mode power supply comprising:
a transformer having a primary winding coupled to receive power derived from said input power rail;
an auxiliary power supply;
an internal power supply;
a field effect power switch;
a controller having a supply input and a control switch connected in series with the source or drain of the field effect power switch; and
a reservoir capacitor configured to receive current from the auxiliary power supply and to determine voltage on the supply input of the controller, the bootstrap circuit comprising:
a current bleed impedance connected to the internal power supply;
circuitry to deliver current from the internal power supply via the current bleed impedance to the gate of the power switch such that the power switch is operable to amplify the current delivered from the internal power supply;
a passive circuit configured to provide the amplified current to the reservoir capacitor; and
the passive circuit further configured to substantially block reverse current flow from the supply input to the source of the power switch.
